(19) United States
(12) Patent Application Publication
(10) Pub. No.: US 2024/0406220 A1
(43) Pub. Date: Dec. 5, 2024

(54) METHODS AND SYSTEMS FOR VOICE SERVICES

(71) Applicant: Comcast Cable Communications, LLC, Philadelphia, PA (US)

(72) Inventors: Daniel Grady, Philadelphia, PA (US); Mary Malone, Philadelphia, PA (US); Eugene Nolan, Philadelphia, PA (US); Alex Model, Philadelphia, PA (US)

(21) Appl. No.: 18/327,601

(22) Filed: Jun. 1, 2023

(51) Int. Cl. H04L 65/1059; G10L 15/22; H04L 65/1069

(52) U.S. Cl. CPC H04L 65/1059; G10L 15/22; H04L 65/1069; G10L 2015/223

(57) ABSTRACT

Methods and systems for interfacing with a voice service are described. A premises device may detect a trigger event and establish a communication session with a voice service based thereon.

### BACKGROUND

Voice enabled devices provide user friendly interfaces between users and voice services behind the voice enabled devices. The voice enabled devices constantly listen for a user to speak a wake word configured to activate the device and, when the wake word is detected, the voice enabled device engages with the voice service to respond to a user input like a user query or a command. However, conventional voice enabled devices, in order to detect the wake word, must keep a microphone on at all times. This presents a privacy concern.

### SUMMARY

It is to be understood that both the following general description and the following detailed description are exemplary and explanatory only and are not restrictive. Voice services are configured to respond spoken user inputs. Voice enabled devices are typically activated by detecting a wake word. A voice service, such as a smart voice assistant, can be accessed based on detecting a trigger event other than a wake word. The trigger event can be any event that would not be considered a traditional conventional wake word alone. A communication session between a voice enabled device and a voice service may be opened based on detecting the trigger event. This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, show examples and together with the description, serve to explain the principles of the methods and systems:

FIG. 1 shows an example system;

FIG. 2 shows an example system;

FIGS. 3A-3B show example systems;

FIGS. 4A-4C show example systems;

FIG. 5 shows an example method;

FIGS. 6A-6B show example flowcharts;

FIG. 7 shows an example method;

FIG. 8 shows an example method;

FIG. 9 shows an example method;

FIG. 10 shows an example method; and

FIG. 11 shows an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

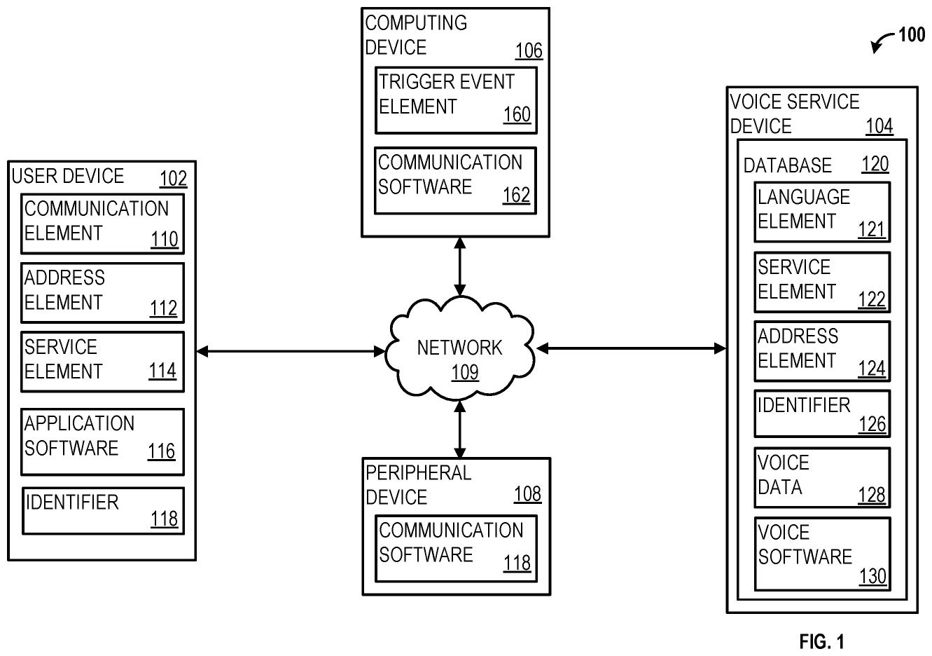

FIG. 1 shows an example system 100. Those skilled in the art will appreciate that digital equipment and/or analog equipment may be employed. One skilled in the art will appreciate that provided herein is a functional description and that the respective functions may be performed by software, hardware, or a combination of software and hardware.

The system 100 may include a user device 102, a voice service device 104, a computing device 106, and a peripheral device 108. The user device 102 may communicate with the voice service device 104, the computing device 106, and/or the peripheral device 108 via a network 109. The network 109 may support communication between the user device 102, the voice service device 104, the computing device 106, and/or the peripheral device 108 via a short-range communications (e.g., BLUETOOTH®, near-field communication, infrared, Wi-Fi, etc.) and/or via a long-range communications (e.g., Internet, cellular, satellite, and the like). For example, the network 109 may utilize Internet Protocol Version 4 (IPv4) and/or Internet Protocol Version 6 (IPv6). The network 109 may be a telecommunications network, such as a mobile, landline, and/or Voice over Internet Protocol (VOIP) provider.

The user device 102 may include a communication element 110, an address element 112, a service element 114, communication software 116, and an identifier 118. The communication element 110 may be configured to communicate via any network protocol. For example, the communication element 110 may communicate via a wired network protocol (e.g., Ethernet, LAN, WAN, etc.) on a wired network (e.g., the network 109). The communication element 110 may include a wireless transceiver configured to send and receive wireless communications via a wireless network (e.g., the network 109). The wireless network may be a Wi-Fi network. The user device 102 may communicate with the voice service device 104, the computing device 106, and/or the peripheral device 108 via the communication element 110.

The user device 102 may be a mobile device, such as a smartphone, or a telephone (e.g., a landline and/or a voice over internet protocol (VOIP) phone). The communication element 110 of the user device 102 may be configured to communicate via one or more of Plain Old Telephone Service (POTS), Public Switched Telephone Network (PSTN), VOIP, second generation (2G), third generation (3G), fourth generation (4G), fifth generation (5G), GPRS, EDGE, D2D, M2M, long term evolution (LTE), long term evolution advanced (LTE-A), code division multiple access (CDMA), wideband code division multiple access (WCDMA), universal mobile telecommunications system (UMTS), wireless broadband (WiBro), Voice Over IP (VOIP), and global system for mobile communication (GSM). The communication element 110 of the user device 102 may further be configured for communication over a local area network connection through network access points using technologies such as IEEE 802.11.

The communication element 110 may be configured to cause one or more packets (e.g., one or more data packets) to be sent. For example, the communication element 110 may be configured to cause the one or more data packets to be sent over a network (e.g., a local area network, a wide area network, the Internet).

The user device 102 may include an address element 112 and a service element 114. The address element 112 may include or provide an internet protocol (IP) address, a network address, a media access control (MAC) address, an Internet address (e.g., an IPV4, an IPv6 address, etc.), or the like. The address element 112 may be used to establish a communication connection between the user device 102, the voice service device 104, the computing device 106, the peripheral device 108, and/or other devices and/or networks. The address element 112 may be an identifier or locator of the user device 102. The address element 112 may be persistent for a particular network (e.g., the network 109).

The service element 114 may include an identification of a service provider associated with the user device 102 and/or with the class of user device 102. The class of the user device 102 may be related to a type of device, capability of device, type of service being provided, and/or a level of service (e.g., business class, service tier, service package, etc.). The service element 114 may include information relating to or provided by a service provider (e.g., Internet service provider, content service provider, communications service provider, etc.) that may provide or enable data flow such as communication services (e.g., a phone call, a video call, etc.) and/or content services to the user device 102. The service element 114 may include information relating to a preferred service provider for one or more particular services relating to the user device 102. The address element 112 may be used to identify or retrieve data from the service element 114, or vice versa. One or more of the address element 112 and/or the service element 114 may be stored remotely from the user device 102. Other information may be represented by the service element 114.

The user device 102 may be associated with a user identifier or device identifier 118. The device identifier 118 may be any identifier, token, character, string, or the like, for differentiating one user or user device (e.g., the user device 102) from another user or user device. For example, the device identifier 118 may be or relate to an Internet Protocol (IP) Address, a Media Access Control (MAC) address, an International Mobile Equipment Identity (IMEI) number, an International Mobile Subscriber Identity (IMSI) number, a phone number, a SIM card number, and/or the like. The device identifier 118 may identify a user or user device as belonging to a particular class of users or user devices. The device identifier 118 may include information relating to the user device 102 such as a manufacturer, a model or type of device, a service provider associated with the user device 102, a state of the user device 102, a locator, and/or a label or classifier. Other information may be represented by the device identifier 118.

The user device 102 may include application software 116. The application software 116 may be software, firmware, hardware, and/or a combination of software, firmware, and hardware. The application software 116 may allow the user device 102 to access one or more applications. The one or more applications (e.g., “apps”) may be configured to perform specific functions or provide specific content. For example, the one or more applications may be configured for gaming, shopping, gathering/retrieving/outputting content or data, social networking, productivity, entertainment, education, home management (e.g., managing thermostats, appliances, combinations thereof), home security, combinations thereof, and the like. The application software 116 may be configured to send and/or receive data, application services (e.g., a phone call, a video call, etc.), and so forth. For example, the application software 116 may be configured to send or receive one or more packets (e.g., one or more data packets). For example, the application software 116 may be configured to allow the user device 102 to establish a communication connection and/or a communication session with the voice service device 104 via the network 109. The computing device 106 may be configured to detect a device condition associated with the user device. The device condition associated with the user device may comprise the user device sending or receiving data (e.g., the one or more packets). For example, the computing device 106 may comprise a network device and/or a voice enabled device. For example, the computing device 106 may comprise a modem, router, gateway, access point, or the like configured to send, receive, store, detect, or otherwise process one or more data packets. The computing device 106 may be voice enabled device like SIRI or ALEXA.

The computing device 106 may comprise a network device like a router, modem, gateway, or access point. The computing device 106 may be a voice enabled device such as a smart speaker. The computing device 106 may comprise a trigger condition element 160. The trigger condition element 160 may be configured to detect one or more trigger conditions. The one or more trigger conditions may comprise an off hook condition, a power on condition, opening or closing an application, a motion indication, a sensor trigger condition, or any other condition. For example, the device condition may be determined based on the one or more packets (e.g., one or more data packets). The packet may indicate a device condition. The device condition may be associated with, for example, the user device 102 and/or the peripheral device 108. For example, the device condition may be determined (detected) based on one or more data packets may indicate an off hook condition of a phone. The one or more data packets may indicate an application (e.g., an “app” on the user device) has been opened. The one or more data packets may be associated with the one or more IoT devices and may indicate an activation of the one or more IoT devices. For example, the packet may comprise a motion indication associated with a camera, a door open indication associated with a door, a temperature change indication associated with a thermostat or any other data associated with any other IoT device.

The computing device 106 may be configured to establish a communication session with the voice service device 104. For example, the computing device 106 may be configured to establish a communication session with the voice service device 104 based on detecting a trigger event (e.g., the one or more data packets).

The communication session between the computing device and the voice service may be configured to facilitate access to and interaction with a voice service by a user. For example, upon detecting the off hook condition, the user may be able to interact with the voice service via the phone and/or the computing device (e.g., in the case the computing device is a voice enabled device).

The voice service device 104 may include a database 120, a language element 121, a service element 122, an address element 124, an identifier 126, voice data 128, and voice software 130. The voice service device 104 may comprise a cloud-based voice service device. The voice service device 104 may comprise a natural language voice enabled virtual assistant like SIRI or ALEXA.

The database 120 may store a plurality of files (e.g., web pages), user identifiers or records, data associated with a plurality of devices, data associated with a plurality of services, data associated with a plurality of user utterances, supplemental data, and/or other information. The user device 102, the computing device 106, and/or the peripheral device 108 may request and/or retrieve a file from the database 120. The database 120 may store information relating to the user device 102 such as the address element 112 and/or the service element 114. The voice service device 104 may obtain the device identifier 118 from the user device 102 and retrieve information from the database 120. Any information may be stored in and retrieved from the database 120. The database 120 may be disposed remotely from the voice service device 104 and accessed via direct or indirect connection. The database 120 may be integrated with the voice service device 104 or some other device or system.

The voice service device 104 may have a service element 122. The service element 122 may include an identification of a service provider associated with the voice service device 104 and/or with the class of computing device 104. The class of the voice service device 104 may be related to a type of device, capability of device, type of service being provided, and/or a level of service (e.g., business class, service tier, service package, etc.). The service element 122 may include information relating to or provided by a communication service provider (e.g., Internet service provider, communications service provider, etc.) that is providing or enabling data flow such as communication services to the voice service device 104. The service element 122 may include information relating to a preferred service provider for one or more particular services relating to the voice service device 104. Other information may be represented by the service element 122.

The address element 124 may include or provide an internet protocol address, a network address, a media access control (MAC) address, an Internet address, or the like. The address element 124 may be relied upon to establish a communication session between the voice service device 104 and the user device 102, the computing device 106, and/or the peripheral device 108, or other devices and/or networks. The address element 124 may be used as an identifier or locator of the voice service device 104. The address element 124 may be persistent for a particular network.

The voice service device 104 may have an identifier 126. The identifier 126 may be or relate to an Internet Protocol (IP) Address, a Media Access Control (MAC) address, or the like. The identifier 126 may be a unique identifier for facilitating wired and/or wireless communications with the user device 102, the computing device 106, and/or the peripheral device 108.

The voice service device 104 may store voice data 128 in the database 120. The voice data 128 may include any data associated with one or more user utterances received from the user device or any other device (e.g., other user devices), the computing device 106, and/or the peripheral device 108. For example, a voice enabled device (e.g., a computing device, a smart device, etc.) may receive a plurality of voice inputs. The voice enabled device may also receive a plurality of natural language queries and/or commands. The voice enabled device may receive the plurality of voice inputs via a sensor (e.g., a microphone, etc.). The voice enabled device may have one or more speech recognition modules configured to interpret the plurality of voice inputs. The voice enabled device may determine a result, a response, an intent, and/or the like of each of the plurality of voice inputs. The voice enabled device may perform speech-to-text operations that translate each of the plurality of voice inputs to respective text, a plurality of characters, and/or the like. The voice enabled device may apply one or more speech/language recognition algorithms to a voice input and extract a word or a plurality of words (e.g., a phrase) from the voice input.

Each of the plurality of voice inputs may be analyzed based on syntactic properties and/or a hierarchical order. Voice inputs, such as “I want to watch a movie,” or “Show me a movie,” may be analyzed and, based on a root word/phrase (e.g., “I want,” “show me,” etc.), a respective dependency tree structure (e.g., a data structure, a syntactic tree, a parse tree, etc.) may be generated for each voice input. Each dependency tree structure may have a plurality of tags (e.g., parser labels, etc.) that indicate and/or are associated with a portion of a respective voice input (e.g., a part of speech, etc.). The plurality of tags may include tags such as “NN” (e.g., a noun), “VB” (e.g., a verb), “JJ” (e.g., an adjective), “RB” (e.g., an adverb), combinations thereof, and the like. Each dependency tree structure may be stored as a query set (e.g., a data set, a file, a record, etc.) and associated with an identifier. The identifier may be used as an indicator and/or a classifier of the respective voice input. The identifier may be used to retrieve, provide, send, receive, and the like any information associated with a respective dependency tree structure (e.g., query set).

A plurality of voice inputs may yield a plurality of dependency tree structures (e.g., data structures, syntactic trees, parse trees, query sets, etc.). The plurality of dependency tree structures may be grouped and/or associated with each other. At least a portion of the plurality of dependency tree structures may be grouped and/or associated based on a respective root word/phrase. The plurality of dependency tree structures may be grouped and/or associated based on any relationship, property, or the like. Dependency tree structures may be grouped and/or associated to form dependency tree clusters (e.g., query clusters, cluster sets, data clusters, etc.). A plurality of dependency tree structures may yield a plurality of dependency tree clusters. The plurality of dependency tree clusters may be sorted. The plurality of dependency tree clusters may be sorted based on a total frequency of voice inputs (e.g., natural language queries, queries, etc.) associated with a respective dependency tree cluster.

The dependency tree structures may be used to generate/predict responses to voice inputs the voice enabled device (or a device/system associated with the voice enabled device) may receive. The dependency tree structures may be associated with a neural network. The dependency tree structures may be used to train a neural network to predict and/or identify proper responses (e.g., actions, correct responses, intents, operations, commands, etc.) to voice inputs.

The peripheral device 108 may comprise one or more internet of things devices (IoT devices). The peripheral device 108 may further be configured for communication over a local area network connection through network access points using technologies such as IEEE 802.11. For example, the communication software 118 may be configured to establish a phone call and/or a video call. The one or more IoT devices 206 may comprise one or more of: a smart thermostat, a smart home assistant, a smart lock, smart lighting, smart appliances (e.g., refrigerator, oven, washing machine, dryer, or any other home appliance that can be controlled remotely), smart wearable devices, smart camera (e.g., a security camera), smart irrigation system (e.g., a sprinkler), smart parking systems (e.g., sensors or cameras configured to aid in parking), combinations thereof, and the like.

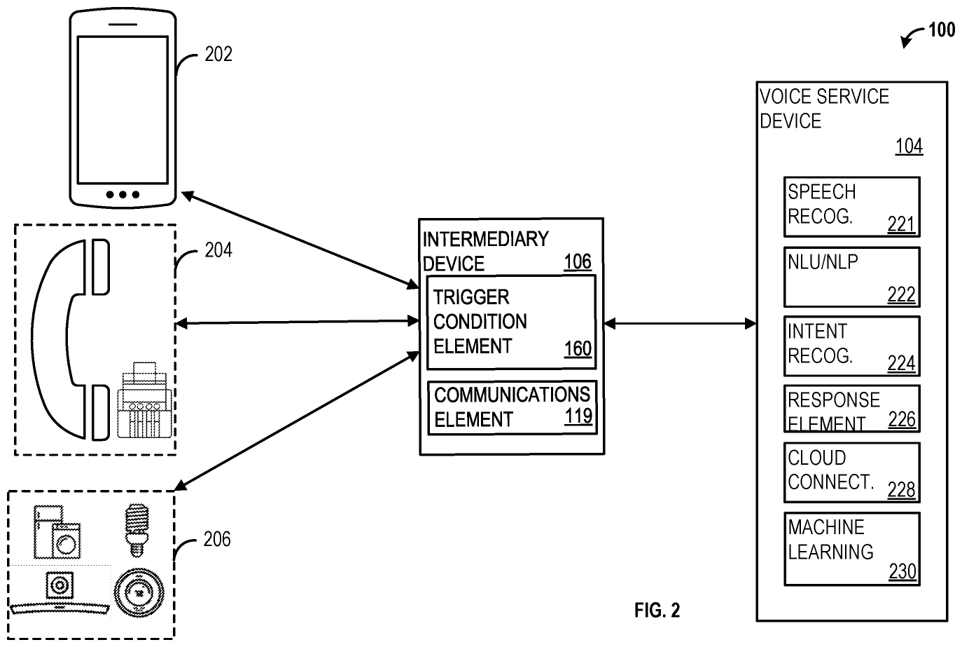

FIG. 2 shows an example system 200. The system may comprise the user device 102, a landline phone 204, one or more internet of things (IoT) devices 206, the voice service device 104, and the computing device 106. The one or more IoT devices 206 may comprise one or more of: a smart thermostat, a smart home assistant, a smart lock, smart lighting, smart appliances (e.g., refrigerator, oven, washing machine, dryer, or any other home appliance that can be controlled remotely), smart wearable devices, smart camera (e.g., a security camera), smart irrigation system (e.g., a sprinkler), smart parking systems (e.g., sensors or cameras configured to aid in parking), combinations thereof, and the like.

The voice service device 104 may be configured with a speech recognition element 221 configured to use speech recognition technology to convert a user's spoken words into text. The text may be used to execute one or more commands and/or respond to one or more queries. The voice service device 104 may comprise a natural language understanding/natural language processing (NLU/NLP) element 222. The NLU/NLP element 222 may be configured to interpret the meaning of a user's command or query. The voice service device 104 may comprise an intent recognition element 224. The intent recognition element 224 may be configured to identify an intent behind a command or query in order to determine an appropriate response. The voice service device 104 may comprise a response element 226. The response element 226 may be configured to generate one or more responses. The response element 226 may generate the one or more responses based on the received queries or commands. The one or more responses may comprise one or more spoken responses (e.g., audible to a user), one or more visual responses, one or more haptic responses, one or more actions combinations thereof, and the like. For example, the one or more actions may be turning a light on or off, activating speakers or microphones to output or receive audio, locking or unlocking doors, activating or deactivating appliances (e.g., refrigerator, thermostat, air conditioner, washing machine, dryer, etc. . . . ), combinations thereof, and the like.

The voice service device 104 may comprise a cloud connectivity element 228. The cloud connectivity element 228 may be configured to connect the voice service device 104 to one or more databases storing data to be used in natural language processing and to communicate with other devices.

The voice service device 104 may comprise a machine learning element 230. The machine learning element 230 comprising a machine learning model. The machine learning model may be configured to analyzing patterns in speech, identifying intent behind requests, and trigger an appropriate response or action. The model may be trained using large amounts of data, including audio recordings of speech and transcripts of text, and configured to learn the patterns and relationships between the words and phrases used in language.

The computing device 106 may comprise a network device like a router, modem, gateway, or access point. The computing device may be a voice enabled device such as a smart speaker. The computing device 106 may comprise a trigger condition element 160. The trigger condition element 160 may be configured to detect one or more trigger conditions. The one or more trigger conditions may comprise device condition. The device condition may be associated with, for example, the user device 202, the landline phone 204, or any one or more IoT devices 206.

For example, the packet may originate from the user device 202. For example, the packet may indicate an application has been opened on the user device. For example, the packet may originate from one or more of the IoT devices 206. For example, the packet may be sent from a smart refrigerator indicating a door of the refrigerator has been opened. For example, the packet may originate from one or more of an inline adapter or eDVA associated with the landline phone 204. The packet may indicate the phone is off the hook.

Based on detecting the device condition, the computing device may establish a communication session with the voice service 104. The communication session may comprise a communication channel. The communication channel may be a direct channel or an indirect channel. For example, in the case that the packet originated from an IoT device, the communication session may comprise a communication session between the computing device and the voice service device. For example, a smart refrigerator may detect a door open condition (e.g., a user opened the refrigerator door) and the smart refrigerator may send a packet based thereon. A network device (e.g., the computing device) may detect the device condition and establish a communication session based thereon. For example, the computing device may be a voice enabled device such as an ALEXA. The voice enabled device may open a communication session with the voice service. Based on determining the packet originated from a refrigerator, the voice service may cause output of an inquiry such as, “Do you need to add anything to your grocery list?”

For example, the packet may originate from a security device such as a door sensor, window sensor, security camera, motion detector, combinations thereof, or the like. For example, the security device may detect a door opening, a motion indication, or the like and send a packet to, for example, a security server. The packet may be routed through a network device (e.g., the computing device) such as a modem or gateway from a LAN to a WAN (e.g., the Internet). The network device may determine the packet originated from a security device and cause a voice enabled device to establish a communication session with the voice service. For example, the data originating from the security device may cause the voice service to output, via the voice enabled device, an audio output such as “welcome home!” or “Is that you, Dave?”

The packet may originate from a user device such as a smart phone. For example, a user may open an application on the smart phone and based thereon, the application, the smart phone itself may cause a packet to be sent. For example, upon opening the application, one or more packets associated with credentialing either the user or the user device may be sent or received. The one or more packets may be detected by a network device (e.g., a router, a modem, the voice enabled device). Based on detecting the condition, the computing device may establish a communication session with the voice service. For example, the communication session may be open directly between the computing device and the voice service (e.g., the computing device may receive voice inputs and send voice data to the voice service). For example, the computing device may open a communication session with both the user device and the voice service. For example, the voice inputs may be received by the user device, sent to the computing device, and the computing device may forward the voice inputs to the voice service.

The packet may originate from a device associated with a landline telephone. For example, the packet may originate from an inline voice adapter and/or an embedded Digital Voice Adapter (eDVA). The packet originating from the device associated with the landline phone may indicate an off hook condition of the landline phone. For example, the inline voice adapter and/or the eDVA may detect a vertical service code and/or pilot number outgoing from the landline phone and send a packet either to the computing device and/or directly to the voice service (e.g., via the internet). Thus, the landline phone can be configured to support access to and interaction with the voice service via the landline phone without the need to speak a wake word.

The communication session with the voice service may be closed. For example, the communication session with the voice service may be closed based on, for example, detecting a dial command, detecting a call command, detecting a second packet, combinations thereof, and the like. For example, a user may interact with one or more buttons on the phone (e.g., dial a phone number). Based on the dial command, the computing device may tear down the communication session with the voice service.

The communication session may be closed based on a detection of a call command. The call command may comprise a spoken command (e.g., a dialless command) configured to cause the phone to place a call (e.g., “call Ben”). Based on the dial command being detected, the communication session with the voice service may be closed.

For example, pressing a button or speaking a call command may cause the phone to send one or more electrical signals towards a central office. The one or more signals bound for the central office may be detected by the inline voice adapter and/or the eDVA. Based on detecting the one or more electrical signals, the inline voice adapter and/or the eDVA may send a channel close signal to the computing device (e.g., the voice enabled device) configured to cause the computing device to close the communication session with the voice service.

The system may comprise a voice-driven residential VOIP phone service system comprising a premises device configured to facilitate a communication session with a voice service, a landline phone connected to a VOIP adapter, an off-hook detection device configured to detect an off-hook condition, a dialing device configured to cause the VOIP adapter, and a voice recognition module configured to recognize one or more voice commands. The VOIP adapter may be configured to facilitate the communication session with the voice service. The premises device may comprise a voice-driven residential VOIP phone service. The premises device may comprise a landline phone, the VOIP adapter, a voice-enabled device, an RJ jack, and/or a smart phone. The voice service may be a cloud based voice service. The cloud-based voice service may provide a voice-driven interface that enables a user to initiate and manage phone calls using voice commands. The voice-driven interface may include options to dial phone numbers, call contacts from an address book, receive and manage voicemail messages, and access other phone features using voice commands. The premises device may be configured to terminate the communication session upon detection of a dial command. The system may comprise a feedback module configured to provide audible feedback to a user indicating a status of a phone call, including call connection, disconnection, and other relevant information.

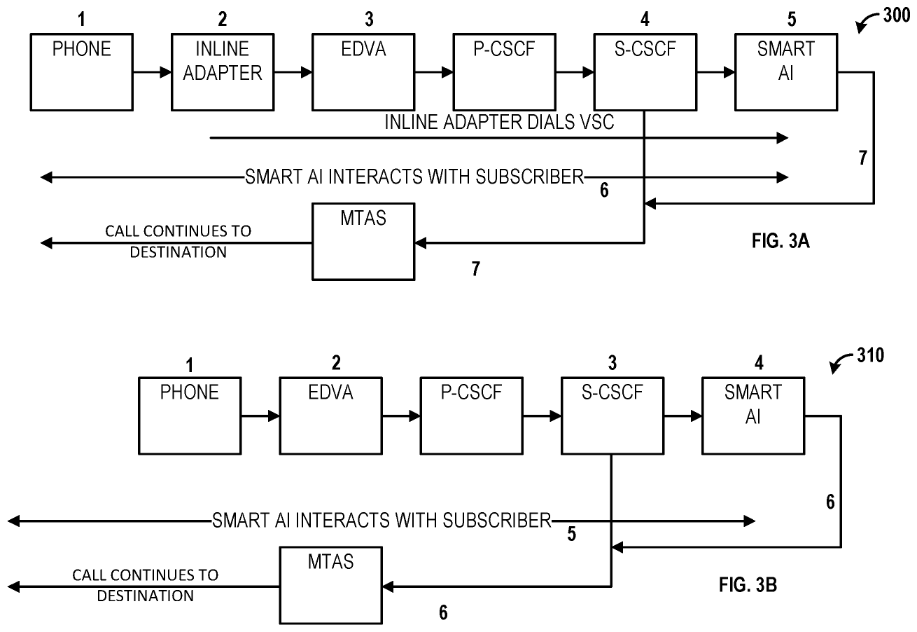

FIG. 3A shows an example method 300. The method 300 may be carried out via any one or more of the devices described herein. The method 300 may be configured to facilitate a call channel setup without dialing when an off hook condition is detected. The off hook condition may be detected by an inline adapter (or other physical medication) for the phone. For example, the inline adapter may be an RJ plug (e.g., RJ9, RJ11, RJ45). At step 310, a user device (e.g., a phone) may go off hook. The user device may be a home phone. At 320, the inline adapter may detect the off hook status. The inline adapter may, based on detecting the off hook status, dial a vertical service code (VSC), a star code, a feature code, or a pilot number. The VSC may be detected by the inline adapter. Dialing the VSC or pilot number may cause a session initiation protocol (SIP) invite to be sent by the inline adapter to an embedded Digital Voice Adapter (eDVA). In an embodiment, as shown in FIG. 3B. (system 310) an upgraded eDVA may detect the off hook condition rather than an inline adapter.

At 330, the eDVA may signal the SIP invite to an (IP) Multimedia Subsystem (IMS) core. The IMS core may comprise a network architecture used in modern telecommunications networks to provide multimedia services over IP networks, including voice, video, and data services. The IMS core may be configured as a central control point for these services, managing the signaling and routing of multimedia sessions across different types of networks and devices. The IMS core may comprise a Call Session Control Function (CCSF) configured to manage call setup and tear-down, as well as the routing of multimedia sessions between different networks and devices. The IMS core may comprise a Home Subscriber Server (HSS) configured to store subscriber information, such as user profiles, authentication data, and service preferences. The IMS core may comprise a Media Resource Function (MRF) configured to provide media processing capabilities, such as transcoding, mixing, and conferencing, for multimedia sessions. The IMS core may comprise an application server (AS) configured to host and executes services and applications, such as voicemail, messaging, and video conferencing. The invite may be sent to a proxy Call Session Control Function (pCSCF). The pCSCF may be configured as a first contact point for users of the IMS. The pCSCF may function as a proxy server for the user equipment configured to all SIP signaling traffic to and from the user device.

At 340, a serving Call Session Control Function (s-CSCF) may examine the originating Initial Filter Criteria (IFC) and send the SIP invite towards a smart AI service (e.g., the voice service).

At 350, the smart AI may examine the SIP invite and determine the VSC (or pilot number, etc.). The smart AI may answer the call with early media. For example, the smart AI may answer the call with a provisional response configured to indicate that indicates that the recipient of a SIP request is processing the request and has started to send the requested information or media. For example, the smart AI may respond via SIP 183 protocol. The smart AI may announce to a subscriber, “Just say, ‘Hey XFINITY, what can you do?’” The smart AI may be configured to respond to voice commands from a user. The user may still enter phone numbers instead of speaking a request as the smart AI agent is configured to interpret both Dual Tone Multi-Frequency (DTMF) tones and spoken requests, thus phone dialing functionality is retained.

At 360, the smart AI may interact with a user. Optionally, at 370, a call may be placed and the call may continue towards its destination via a multimedia Telephone Application Server (mTAS). The mTAS may be configured to provide supplementary multimedia service on IMS between users. Thus, users can communicate in a richer environment. The mTAS may be configured to provide services such as caller ID, origination-denial, termination-denial, call forwarding, ring back tone service, voice message service, lettering service (so information specified by the caller such as a nickname can be displayed to the receiver when the call is connected), call hold service, voice messaging service, call waiting, combinations thereof, and the like. Optionally, at 370, the communication session with the smart AI may be torn down based on a call being placed (e.g., a user entering a dial command into the user device).

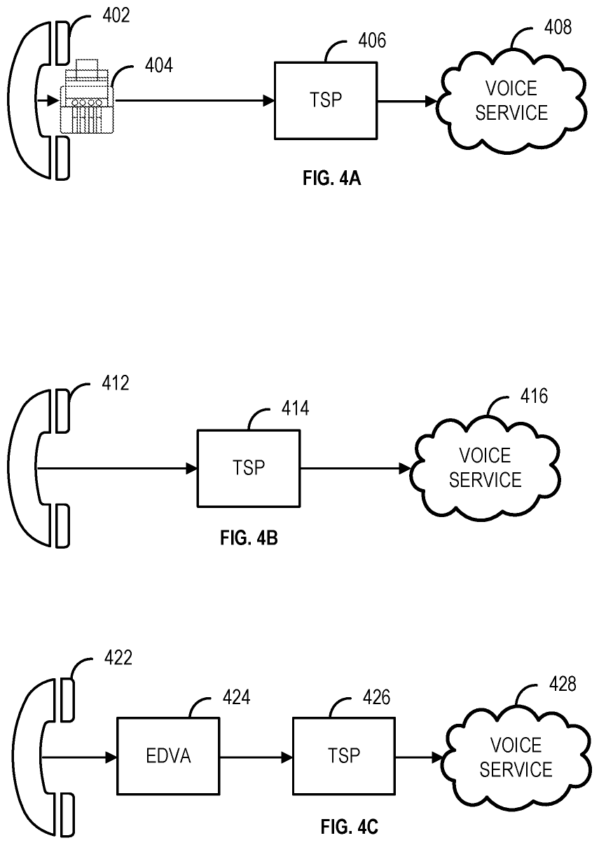

FIGS. 4A-4C show example systems. FIG. 4A shows example system 400. The system 400 may comprise a standard land line phone 402, an RJ 45 compatible off hook detector 404, a telephone service provider (TSP) 406, and a voice AI service 408 (e.g., the voice service 104). The RJ45 compatible off hook detector may comprise a programmable dialer with a deactivation switch. The deactivation switch may be configured to detect a dial command and thus facilitate a standard dial use of the phone 402. The RJ45 compatible device may be configured to plug into a standard landline phones RJ45 jack. When the RJ45 device detects a dial-tone caused by an off hook condition of the phone 402, the RJ45 device may send one or more DTMF signals (e.g., a vertical service code, pilot number, combinations thereof, or the like). The one or more DTMF signals may be configured to invoke an AI feature server. The AI feature server may be configured to provide a wide array of smart-speaker services and may also be configured to support traditional phone dialing. The dialless phone 402 may comprise one or more microphones and/or one or more speakers configured to receive the one or more voice commands and/or output one or more voice responses received from the voice service 408. A voice command of the one or more voice commands may be a dial command (e.g., a call command, a command to place a call). Thus, users can speak to place outgoing calls. If an outgoing call is placed, the call may be routed normally and the connection to the voice service 408 may be terminated.

FIG. 4B shows an example system 410. The system 410 may comprise a dialless phone 412. The dialless phone 412 may comprise a programmable off hook detector and auto dialer. For example, the programmable off hook detector may detect an off hook condition of the phone 412 and automatically send a signal or place a call based on the off hook condition. The dialless phone 412 may comprise a standard landline phone and a dialless RJ45 device in a single device. The dialless phone 412 may or may not comprise buttons. The dialless phone 412 may comprise an autodialing element. The autodialing element may be internal to the dialless phone 412. The autodialing element may be configured to detect an off hook status. The autodialing element may be configured to send one or more DTMF signals (e.g., vertical service code, pilot number, or the like). The one or more DTMF signals may be configured to access, activate, invoke, the voice service 416. The voice service 416 may comprise an AI feature. The voice service may be configured to provide one or more smart speaker services. The one or more smart speaker services may be activated based on one or more voice commands received by (e.g., via) the dialless phone 412. The dialless phone 412 may comprise one or more microphones and/or one or more speakers configured to receive the one or more voice commands and/or output one or more voice responses received from the voice service 416. A voice command of the one or more voice commands may be a dial command (e.g., a call command, a command to place a call). Thus, users can speak to place outgoing calls. If an outgoing call is placed, the call may be routed normally and the connection to the voice service 416 may be terminated.

FIG. 4C shows an example system 420. The system 420 may comprise a phone or other device capable of receiving audio inputs 422, an embedded Digital Voice Adapter (eDVA) 424, a telephone service provider 426, and a voice service 428 (e.g., the voice service 104). The eDVA may be configured to detect an off hook condition of the phone 422. The eDVA 424 may be configured to connect with the voice service 428 based on detecting the off hook condition. For example, the eDVA may comprise firmware configured to connect to the voice service. The

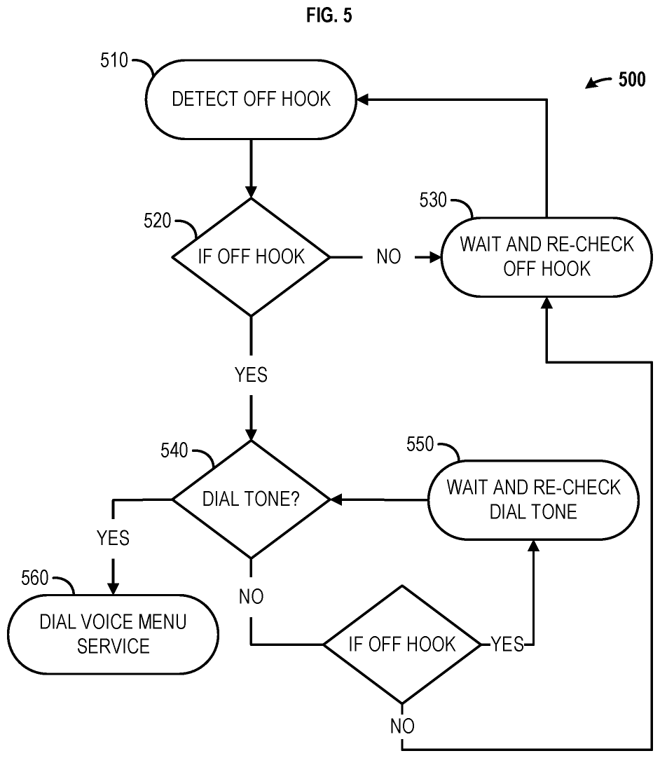

FIG. 5 shows an example method 500. At 510, an off hook condition may be detected. At 520, if the off hook condition is not present, the method may wait and recheck the off hook condition. If the off hook condition is present, the method may proceed to 540, where a determination may be made as to whether or not a dial tone is present. If the dial tone is not present, the method may proceed to 550, where the method waits and rechecks for a dial tone. If the dial tone is present, the method may proceed to step 560, where a call is placed to a voice menu service.

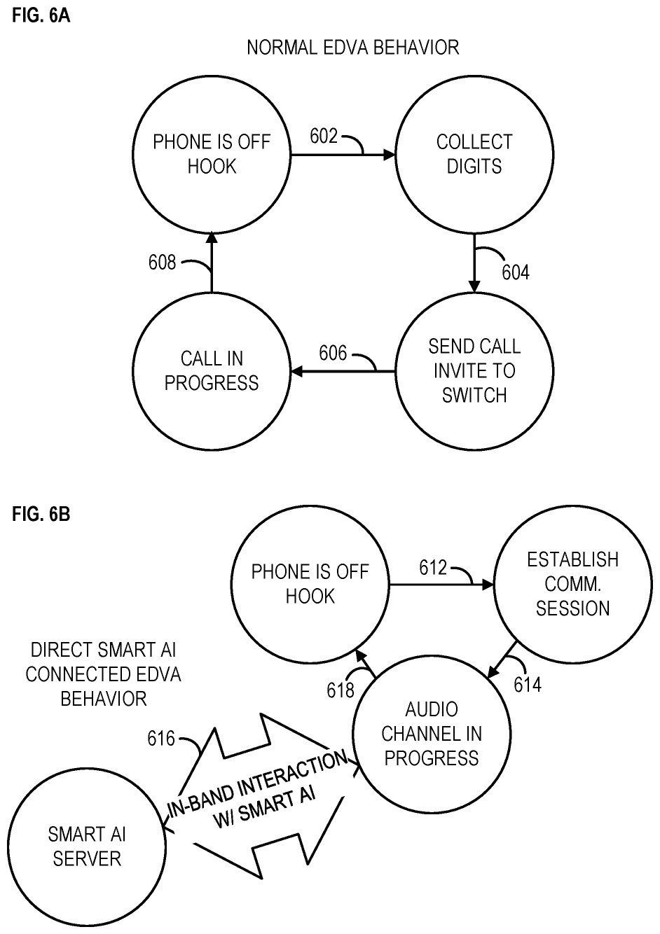

FIG. 6A shows a diagram of normal embedded Digital Voice Adapter (eDVA) behavior. The eDVA may comprise a DOCSIS cable modem (CM) integrated with a PacketCable DVA. The eDVA may be configured to convert one or more analog voice signals into one or more digital IP packets configured for transport over an IP network. As shown in FIG. 6A, a phone may be in an initial “on hook” state. The phone may go off hook (e.g., as a result of a user action) at 602. When the phone goes off hook, one or more digits may be entered into the phone. The one or more digits may be configured to initiate a call sequence at 604. The one or more digits may be configured to send a call invite to a central switch. The central switch may connect the calling phone to an intended recipient phone, and the call may progress and 606. At the end of the call, one or more users may terminate the call by, for example, hanging up the phone. When the phone is placed back on the hook, the communication session may be closed and the phone may be returned to its on hook state at 608 until the phone goes off hook again.

FIG. 6B shows an example diagram of a Direct Smart AI connect eDVA behavior. As shown in FIG. 6B, a phone may be in an initial on hook state. The phone may go off hook (e.g., as a result of a user action). When the phone goes off hook at 612, a call may be automatically placed. The call may be configured to establish a media channel connection with a smart AI service (e.g., the voice service) at 614. The communication session with the smart AI service may comprise an in-band interaction at 616. At 618, the phone may be in an on hook condition until it is off hook again.

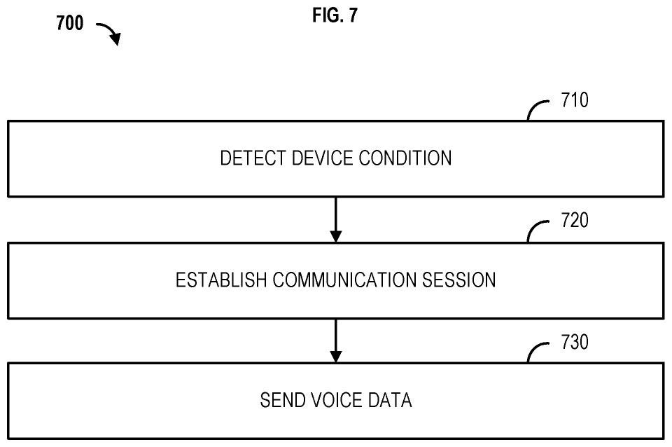

FIG. 7 shows an example method 700. The method may be carried out via any one or more of the devices described herein. At 710, a computing device may detect a device condition associated with a user device. The computing device may comprise an intermediary device between the user device and a voice service device. The device condition may comprise one or more of: a power on condition, an off hook condition, an on-hook condition, a power on condition, a power off condition, an application launch condition, an application close condition, a user interaction with the user device, combinations thereof, and the like. Detecting the device condition may comprise detecting a packet. The device condition may be associated with a user device. The user device may comprise, for example, a landline phone, a smartphone, a VOIP phone, a computer, a laptop, a voice enabled device, combinations thereof, and the like. The packet may comprise one or more of or be indicative of one or more of: a power on signal, a voice over internet protocol (VOIP) packet, network traffic, an off-hook condition, a dial-tone, a wake word, or a user interaction.

At 720, a communication session may be established. The communication session may take place via a communication channel opened between the user device and a voice service. The voice service may be a cloud-based service. The voice service may comprise one or more of: a cloud-based interactive voice response system (e.g., a voice-based virtual assistant configured with natural language processing), a preconfigured menu, a chatbot, a combination thereof, or the like. Opening the communication session may comprise one or more of: sending a vertical service code, sending a pilot number, sending a session initiation protocol (SIP) invitation, dialing into a cloud-based voice menu, combinations thereof, or the like. The communication session may be opened automatically upon detection of the packet indicating the device condition.

At 730, voice data may be send to the voice service. The voice data may be sent to the voice service via the communication session. The voice data may comprise one or more user utterances. The one or more user utterances may comprise, for example, one or more queries, one or more commands, combinations thereof, or the like.

The method may comprise causing the voice service device to determine one or more commands. The method may comprise receiving, from the voice service device, one or more responses associated with the one or more commands. The method may comprise causing the user device to output the one or more responses. The method may comprise determining based on the voice data, one or more commands. The method may comprise causing the voice service device to execute the one or more commands. The method may comprise closing the communication session. The communication session may be closed based on a dial command. The dial command may be detected at (e.g., received via) the user device. For example, the dial command may comprise a spoken command or an interaction with an interface configured to place a call.

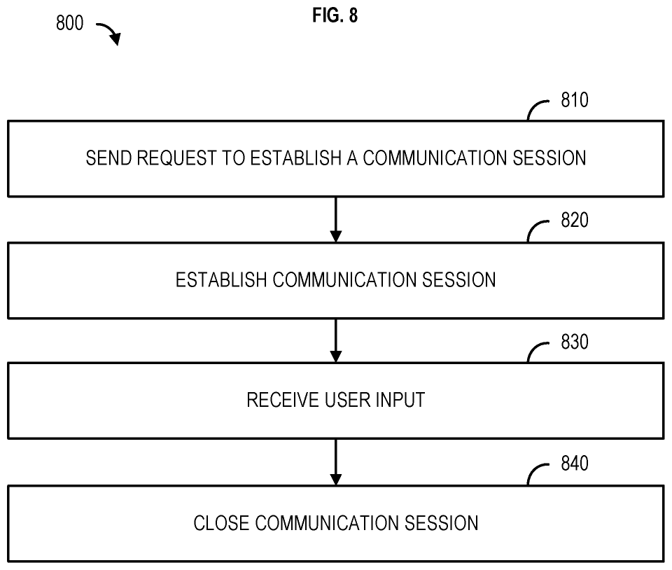

FIG. 8 shows a flowchart of an example method 800. The method may be carried out via any one or more of the devices described herein. At 810, a computing device may send a request to establish a communication session. For example, an computing device may send a request to open a communication session. The computing device may comprise, for example, a voice enabled device, VOIP adapter, combinations thereof, and the like. The computing device may send the request based on a trigger condition associated with a user device. The request may be associated with a voice service wherein the voice service comprises one or more of: a cloud-based interactive voice response system, a preconfigured menu, or a chatbot. The trigger condition may comprise, for example, one or more of: a power on signal, a voice over internet protocol (VOIP) packet, network traffic, an off-hook condition, a dial-tone, a wake word, a user interaction, combinations thereof, and the like.

At 820, a communication session may be established. For example, a session channel may be opened between the user device and the voice service. The communication session may comprise a direct communication session between the user device and the voice service. The communication session may comprise an indirect communication session between the user device and the voice service. The indirect communication session may comprise one or more the computing device and/or one or more other devices. Establishing the communication session may comprise one or more of: receiving a vertical service code, receiving a pilot number, receiving a session initiation protocol (SIP) invitation, or sending the SIP invitation.

At 830, a user input may be detected. The user input may be associated with (e.g., received via) the user device. The user input may comprise a dial command. The dial command may be a spoken command to place a call. The dial command may comprise one or more button presses configured to place a call. The user input may comprise opening or closing one or more applications.

At 840, the communication session may be closed. The communication session may be closed based on detecting the user input associated with the user device.

The method may comprise receiving, via the communication session, voice data. The method may comprise determining, based on the voice data, one or more user utterances. The method may comprise determining, based on the one or more user utterances, one or more actions. The method may comprise executing the one or more actions. The method may comprise receiving, via the communication session, voice data. The method may comprise determining, based on the voice data, one or more user utterances. The method may comprise determining, based on the one or more user utterances, one or more responses. The method may comprise causing the user device to output the one or more responses.

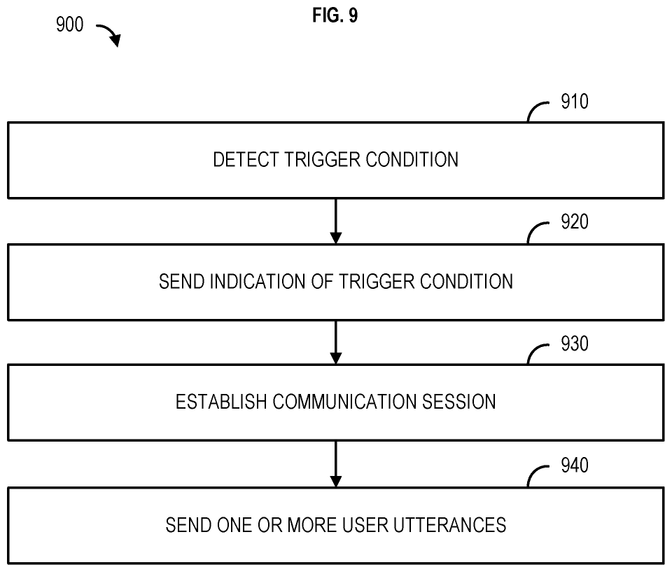

FIG. 9 shows a flowchart of an example method 900. The method may be carried out via any one or more of the devices described herein. At step 910, a trigger condition may be detected. The trigger condition may be detected by a user device. The user device may comprise a smart phone, a voice enabled device, a land-line phone, a computer, a laptop, combinations thereof, or the like. The trigger condition may comprise one or more of: a power on signal, a voice over internet protocol (VOIP) packet, network traffic, an off-hook condition, a dial-tone, a wake word, a user interaction, combinations thereof, and the like.

At 920, an indication of the trigger condition may be sent. For example, the user device may send the indication of the trigger condition may be sent to an computing device such a central computing device, a central switching device, or the like. The user device may send one or more of a vertical service code associated with a voice service or a pilot number associated with the voice service. The voice service may comprise a pre-configured voice navigable menu or a voice controlled virtual assistant. The voice controlled virtual assistant may comprise one or more artificial intelligence models, one or more machine learning models, one or more natural language processing/understanding models, combinations thereof, and the like.

At 930, a communication session may be established. The communication session may be established based on the indication of the trigger condition. The communication session may be opened between the user device and the voice service. The communication session may comprise a direct channel between the user device and the voice service. The communication session may comprise one or more computing devices between the user device and the voice service. For example, if the user device comprises a smartphone, the computing device may be a voice enabled device like an AMAZON ALEXA, and the voice service may be a cloud-based voice service.

At 940, one or more user utterances may be sent. The one or more user utterances may comprise one or more queries, one or more commands, combinations thereof, and the like. The one or more user utterances may be detected by a microphone on the user device. The one or more user utterances may be detected by a microphone on the voice enabled device.

The method may comprise receiving a response from the voice service. The method may comprise outputting the response received from the voice service. The method may comprise detecting a dial command. The dial command may be associated with a user input received via the user device. For example, a user may interact with an interface to place a telephone call by, for example, speaking a call command, (e.g., “Hey Siri, call mom”) or by pressing one or more hard or soft keys to dial a phone number or other service. The method may comprise closing the communication session based on the dial command.

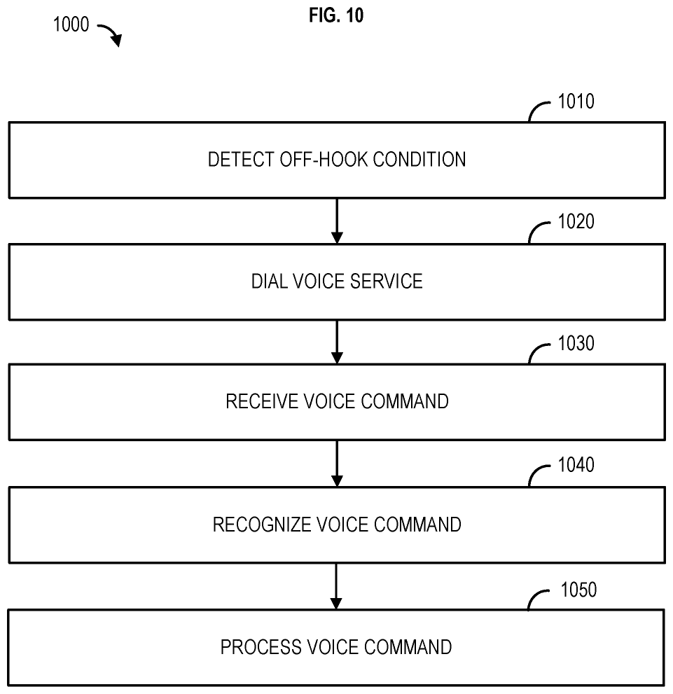

FIG. 10 shows a flowchart of an example method 1000. The method may be carried out via any one or more of the devices described herein. At step 1010, an off-hook condition may be detected. The off-hook condition may be detected by any of the devices described herein. For example, the off-hook condition may be detected based on a land-line phone being removed from its holder. When the phone is removed from its holder, the phone may send an off-hook signal to a local central office or switching center. The off-hook signal may comprise an electrical signal sent from the phone. The off-hook signal may be detected by an intermediary device such as an RJ9 jack or an RJ11 jack. The aforementioned are merely exemplary and explanatory and not restrictive. The computing device may comprise a router or modem configured to detect (e.g., receive) the off-hook signal via an Ethernet cable. The off-hook condition may be detected based on a dial-tone. The dial-tone may be sent by the central switching office and received by the phone

At 1020, a communication session with a cloud-based voice service may be established. For example, a call may be placed to the cloud-based voice service. The cloud-based voice service may be a pre-configured voice enabled menu or a natural language voice service. The communication session may be opened between the cloud-based voice service and a landline phone, a smart phone, a voice enabled device, combinations thereof, and the like.

At 1030, one or more voice inputs may be received. The one or more voice inputs may be detected by a microphone associated with the user device. The one or more voice inputs may comprise one or more queries, one or more commands, combinations thereof, and the like. The one or more voice inputs may be sent to the voice service for processing.

At 1040, the one or more voice inputs may be processed. Processing the one or more voice inputs may comprise performing natural language processing to determine one or more queries, one or more commands, combinations thereof, and the like.

The method may comprise tearing down the communication session between the user device and the voice service. For example, the communication session may be closed based on detecting a dial command. For example, a user of the user device may, via a user interface, enter a dial command by, for example, pressing a hard or soft button on the user device. For example, the communication session may be closed based on detecting a loop-current interruption.

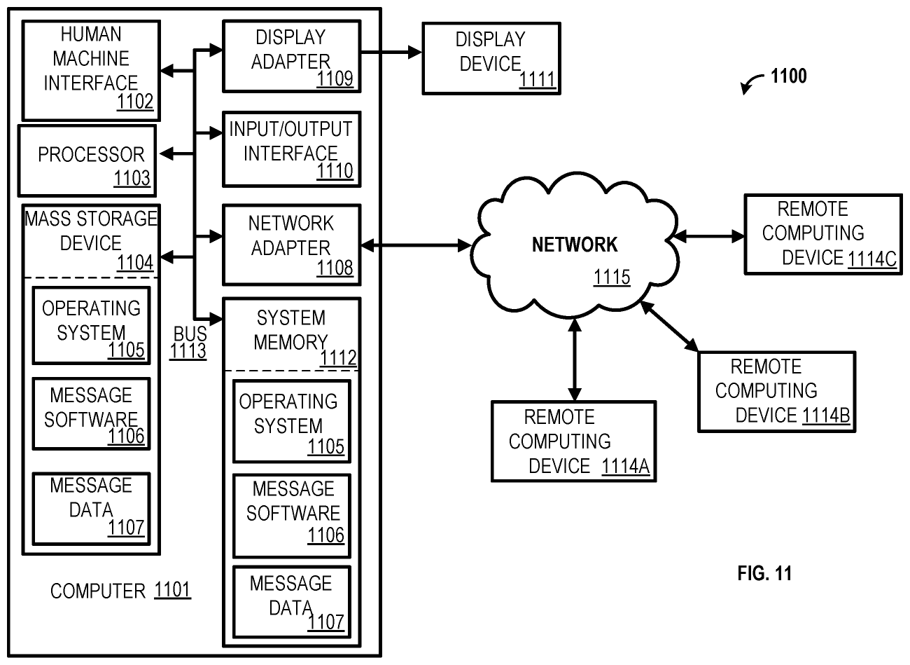

FIG. 11 shows an example system 1100 for modifying/supplementing a message. The user device 102, the computing device 104, the recipient device 106, and/or the message device 108 of FIGS. 1, 2, 3, 4, & 5 may be a computer 1101 as shown in FIG. 11. The computer 1101 may include one or more processors 1103, a system memory 1112, and a bus 1113 that couples various system components including the one or more processors 1103 to the system memory 1112. In the case of multiple processors 1103, the computer 1101 may utilize parallel computing. The bus 1113 is one or more of several possible types of bus structures, including a memory bus or memory controller, a peripheral bus, an accelerated graphics port, or local bus using any of a variety of bus architectures.

The computer 1101 may operate on and/or include a variety of computer readable media (e.g., non-transitory). The readable media may be any available media that is accessible by the computer 1101 and may include both volatile and non-volatile media, removable and non-removable media. The system memory 1112 has computer readable media in the form of volatile memory, such as random access memory (RAM), and/or non-volatile memory, such as read only memory (ROM). The system memory 1112 may store data such as the message data 1107 and/or program modules such as the operating system 1105 and the message software 1106 that are accessible to and/or are operated on by the one or more processors 1103.

The computer 1101 may also have other removable/non-removable, volatile/non-volatile computer storage media. FIG. 11 shows the mass storage device 1104 which may provide non-volatile storage of computer code, computer readable instructions, data structures, program modules, and other data for the computer 1101. The mass storage device 1104 may be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any quantity of program modules may be stored on the mass storage device 1104, such as the operating system 1105 and the message software 1106. Each of the operating system 1105 and the message software 1106 (or some combination thereof) may include elements of the program modules and the message software 1106. The message data 1107 may also be stored on the mass storage device 1104. The message data 1107 may be stored in any of one or more databases known in the art. Such databases may be DB2®, Microsoft® Access, Microsoft® SQL Server, Oracle®, MySQL, PostgreSQL, and the like. The databases may be centralized or distributed across locations within the network 1115.

A user may enter commands and information into the computer 1101 via an input device (not shown). Examples of such input devices include, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 1103 via a human machine interface 1102 that is coupled to the bus 1113, but may be connected by other interface and bus structures, such as a parallel port, game port, an IEEE 1194 Port (also known as a Firewire port), a serial port, network adapter 1108, and/or a universal serial bus (USB).

The display device 1111 may also be connected to the bus 1113 via an interface, such as the display adapter 1109. It is contemplated that the computer 1101 may include more than one display adapter 1109 and the computer 1101 may include more than one display device 1111. The display device 1111 may be a monitor, an LCD (Liquid Crystal Display), light emitting diode (LED) display, television, smart lens, smart glass, and/or a projector. In addition to the display device 1111, other output peripheral devices may be components such as speakers (not shown) and a printer (not shown) which may be connected to the computer 1101 via the Input/Output Interface 1110. Any step and/or result of the methods may be output (or caused to be output) in any form to an output device. Such output may be any form of visual representation, including, but not limited to, textual, graphical, animation, audio, tactile, and the like. The display device 1111 and computer 1101 may be part of one device, or separate devices.

The computer 1101 may operate in a networked environment using logical connections to one or more remote computing devices 1114a,b,c. A remote computing device may be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device, and so on. Logical connections between the computer 1101 and a remote computing device 1114a,b,c may be made via a network 1115, such as a local area network (LAN) and/or a general wide area network (WAN). Such network connections may be through the network adapter 1108. The network adapter 1108 may be implemented in both wired and wireless environments. Such networking environments are conventional and commonplace in dwellings, offices, enterprise-wide computer networks, intranets, and the Internet.

Application programs and other executable program components such as the operating system 1105 are shown herein as discrete blocks, although it is recognized that such programs and components reside at various times in different storage components of the computing device 1101, and are executed by the one or more processors 1103 of the computer. An implementation of the message software 1106 may be stored on or sent across some form of computer readable media. Any of the described methods may be performed by processor-executable instructions embodied on computer readable media.

While specific configurations have been described, it is not intended that the scope be limited to the particular configurations set forth, as the configurations herein are intended in all respects to be possible configurations rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method comprising:
detecting, by a computing device, a device condition associated with a user device;
based on detecting the device condition, establishing a communication session with a user device and a voice service device; and
sending, to the voice service device via the communication session, voice data received via the user device.

2. The method of claim 1, wherein the device condition comprises one or more of: a power on condition, an off hook condition, an application launch condition, or a user interaction with the user device and wherein the computing device comprises one or more of: a digital voice assistant, a network device, an inline voice adapter, or an embedded digital voice adapter (eDVA).

3. The method of claim 1, wherein the device condition comprises one or more of: a power on signal, a voice over internet protocol (VOIP) packet, network traffic, an off-hook condition, a dial-tone, a wake word, or a user interaction.

4. The method of claim 1, wherein computing device is an intermediary device between the user device and the voice service device, and wherein the user device comprises one or more of: a landline phone, a smart phone, a cellular phone, a tablet, or a laptop computer.

5. The method of claim 1, wherein the voice service device comprises one or more of: a cloud-based interactive voice response system, a preconfigured menu, or a chatbot.

6. The method of claim 1, wherein establishing the communication session comprises one or more of: sending a vertical service code, sending a pilot number, sending a session initiation protocol (SIP) invitation, or dialing into a cloud-based voice menu.

7. The method of claim 1, further comprising:
causing the voice service device to determine one or more commands;
receiving, from the voice service device, one or more responses associated with the one or more commands; and
causing the user device to output the one or more responses.

8. The method of claim 1, further comprising:
determining based on the voice data, one or more commands; and
causing the voice service device to execute the one or more commands.

9. A method comprising:
sending, by a computing device, based on a trigger condition associated with a user device, a request to establish a communication session with the user device and a voice service;
establishing the communication session with the user device and the voice service;
detecting a user input associated with the user device; and
based on detecting the user input associated with the user device, closing the communication session with the user device and the voice service.

10. The method of claim 9, wherein the trigger condition comprises one or more of: a power on signal, a voice over internet protocol (VOIP) packet, network traffic, an off-hook condition, a dial-tone, a wake word, or a user interaction.

11. The method of claim 9, wherein the user input comprises a dial command.

12. The method of claim 9, wherein computing device is an intermediary device between the user device and the voice service device, and wherein the user device comprises one or more of: a landline phone, a smart phone, a cellular phone, a tablet, or a laptop computer.

13. The method of claim 9, wherein the request is associated with a voice service and wherein the voice service comprises one or more of: a cloud-based interactive voice response system, a preconfigured menu, or a chatbot.

14. The method of claim 9, wherein opening the communication session comprises one or more of: receiving a vertical service code, receiving a pilot number, receiving a session initiation protocol (SIP) invitation, or sending the SIP invitation.

15. The method of claim 9, further comprising:
receiving, via the communication session, voice data;
determining, based on the voice data, one or more user utterances;
determining, based on the one or more user utterances, one or more actions; and
executing the one or more actions.

16. The method of claim 9, further comprising:
receiving, via the communication session, voice data;
determining, based on the voice data, one or more user utterances;
determining, based on the one or more user utterances, one or more responses; and
causing the user device to output the one or more responses.

17. A method comprising:
detecting, by a user device, a trigger condition;
based on detecting the trigger condition, sending an indication of the trigger condition and one or more of a vertical service code associated with a voice service or a pilot number associated with the voice service, wherein the indication of the trigger condition is associated with the user device;
establishing a communication session with the voice service; and
sending, via the communication session with the voice service, one or more user utterances.

18. The method of claim 17, wherein the trigger condition comprises one or more of: a power on signal, a voice over internet protocol (VOIP) packet, network traffic, an off-hook condition, a dial-tone, a wake word, or a user interaction.

19. The method of claim 17, wherein computing device is an intermediary device between the user device and the voice service device, and wherein the user device comprises one or more of: a landline phone, a smart phone, a cellular phone, a tablet, or a laptop computer.

20. The method of claim 17, wherein establishing the communication session comprises one or more of: receiving a vertical service code, receiving a pilot number, receiving a session initiation protocol (SIP) invitation, or sending the SIP invitation.

21. The method of claim 17, further comprising:
receiving, from the voice service, a response; and
outputting the response.
